(19) United States
(12) Patent Application Publication
(10) Pub. No.: US 2007/0254089 A1
(43) Pub. Date: Nov. 1, 2007

(54) Method and apparatus for the treatment of byproducts from ethanol and spirits production

(76) Inventors: Robert F. Hickey, Okemos, MI (US); Kurt A. Yockel, Rochester, NY (US)

Correspondence Address: GREENBERG TRAURIG (HOU);INTELLECTUAL PROPERTY DEPARTMENT, 2450 COLORADO AVE, SUITE 400E, SANTA MONICA, CA, 90404, US

(21) Appl. No.: 11/787,037

(22) Filed: Apr. 13, 2007

Related U.S. Application Data
(60) Provisional application No. 60/791,762, filed on Apr. 13, 2006.

(51) Int. Cl. A23K 1/08

(52) U.S. Cl. 426/624

(57) ABSTRACT

A method and system for the treatment of byproducts from the production of ethanol or alcohol spirits may include: a screw press to dewater the byproducts to produce a wet cake product and a filtrate product; and an anaerobic reactor to treat to filtrate product.

### RELATED APPLICATION

This Application claims the benefit, and priority benefit, of U.S. Patent Application Ser. No. 60/791,762, filed Apr. 13, 2006, entitled “Method and Apparatus for the Treatment of Distillation Slops From Ethanol and Spirits Production.

### BACKGROUND OF THE INVENTION

1. Field of the Invention

Certain embodiments of the invention relate generally to a method and apparatus for treating byproducts from the production of ethanol and alcohol spirits.

2. Description of the Related Art

Production of ethanol and alcohol spirits results in production of co-products, or byproducts, comprised of spent grains and dead yeast cells. Traditionally these are referred to as “thick slop” or whole stillage which may be used as animal feeds either as slop, concentrated wet cake, or more frequently distillers' dried grains with solubles (“DDGS”). Of these feeds, only DDGS can be stored and shipped reasonable distances, whereas the other animal feeds need to be used locally. DDGS may be produced by using a centrifuge to separate and partially dewater the spent grains, and the material is then dried to have less than 10% moisture content. The remaining water phase, generally referred to as “solubles”, is typically sent to an evaporator and concentrated to a “syrup” of between 25-50% total solids (“TS”). The solubles are either added to the centrifuged grains and dried, or separately dried to have a low moisture content, and are then added back to the dried grains to produce DDGS. Distillers' dried grain without the solubles (“DDS”) has a lower protein and crude fat content, and thus has approximately only 30 to 50% the food value of DDGS. Accordingly, most distilleries and ethanol production facilities, produce DDGS.

The cost of drying the grains and solubles has historically been considerably less than the value of the DDGS and the co-products, or byproducts, handling actually represented a profitable operation. With the emergence of fuel ethanol production, much more DDGS is presently being produced, which has resulted in a significant reduction in the economic value of DDGS in the marketplace. Additional there has been a significant increase in the cost of energy which also results in increased costs to produce DDGS. The evaporation step is also one of the largest gas emissions points in ethanol and spirits facilities, and it would be desirable to reduce such emissions. The result is that making DDGS as is currently done has become a net cost to the spirits and ethanol producers. With the anticipated increase in fuel ethanol production and continued increase in the cost of energy, the situation is likely to worsen. It would be advantageous to have a method and apparatus to manage, or treat, the spent grains and solubles that requires less energy, reduces emissions and results in production of co-products with a value greater than the cost of co-products management, or production.

In the production of alcohol spirits, or products such Kentucky bourbon or other alcohol spirits, there are produced distillery bottoms that need to be treated and include whole stillage. The whole stillage consists of spent grains from the fermentation process for the production of Kentucky bourbon. Grains, such as corn, wheat, or rye, are converted to starches through a mashing process. Grains are blended with water and heated to 200° F. Malt is added to convert the grains to starch. The mash is cooled and then fermented by yeast. This fermentation process produces a mixture of spent grain and alcohol, known as beer. The beer is applied to distillation columns, or stills that utilize steam to vaporize the alcohol. The alcohol vapors are cooled, collected, and ultimately barreled and aged to produce bourbon. The spent grains, removed from the bottom of the stills are called “whole stillage.” The whole stillage is passed over screens, and the liquid that passes through the screen, called “set back,” may be sent back to the mashing process in a conventional manner. The remaining solid liquid mixture, called “thick stillage,” is sent to byproduct/dry house operations.

The thick stillage is pumped to a dewatering unit designed to remove the large particle grains from the water. In the distillery industry, while centrifuges are typically used for dewatering, inclined paddle screens and roller presses may also be used. Thick stillage flows by gravity down parallel inclined screens. Paddles may mix the solids to maximize the removal of free liquid. The semi-thickened grains are then processed through parallel roller presses. The mechanical process presses the solids to remove additional free water. The screen and roller press filtrates are collected and pumped to intermediate storage. The liquid is typically called “thin stillage.” The solids collected from the roller press, which contain roughly 32% to 35% TS, are called “wet grain or “wet cake.” The wet grain is conveyed to steam tube roller dryers and dried to roughly 90% to 95% TS, to produce DDG, which may be stored in grain silos.

The thin stillage collected in the storage tanks may be pumped to an evaporator. Steam and vacuum pressure are used to evaporate water from the thin stillage. Two sources of condensate come off the evaporator: dirty condensate and surface condensate. Both streams are collected and are typically discharged to a sewer. The concentrated thin stillage, or syrup, having approximately 28% TS, is processed through roller film dehydrators. The syrup is applied to steam heated steel rollers, water is vaporized, and a thin dried film is produced, or dried solubles or solubles. The dried solubles are approximately 95% TS. The exhaust is collected via blowers and duct work and sent to a scrubber. The scrubber makes use of tap water to capture and remove particulate and volatile vapors from the gas stream. The scrubber wash water may be discharged to the sewer.

The distillery byproducts, DDG and solubles, are typically blended together to produce DDGS. DDGS are sold as a commodity. However, occasionally solubles and syrup are sold separately as high protein and mineral animal feed ingredients.

Due to the increased production of fuel ethanol and large amounts of DDGS, the market is flooded with DDGS, creating a surplus and driving the value of DDGS down from over $150 per ton just a few years ago to a 2006 market price of $80 per ton. As the cost of energy, electric, coal, and natural gas has greatly increased over the past years, there is a significant increase in the cost to produce DDGS. Byproducts that were once a profit center are now a cost center, thus negatively affecting the bottom line of distillery operations. Additionally the foregoing described equipment is mechanically complex and requires high maintenance efforts to maintain it. Frequently, disruption in distillery production is caused by the need for unscheduled maintenance of the byproduct management system, which can cause bottlenecks and limits the capacity to produce bourbon. Thus, it would be advantageous to have a method and apparatus to treat distillery bottoms that: requires less energy to operate; requires less maintenance; is simpler to manufacture and use; and results in the production of byproducts with a value greater than the cost to treat them.

### SUMMARY OF THE INVENTION

In accordance with the embodiments hereinafter described, the foregoing advantages are believed to have been obtained through the present method for the treatment of byproducts from the production of ethanol or alcohol spirits. This embodiment may include the steps of passing at least a first portion of the byproducts through at least one screw press to dewater the first portion of the byproducts to produce a first wet cake product and a second filtrate product; and passing at least a portion of the second filtrate product through an anaerobic reactor to treat the second filtrate product.

The anaerobic reactor may be utilized to produce a biogas, and the biogas may be used as a source of fuel. The wet cake product may be treated to produce an animal feed product. The byproducts may be chemically pre-conditioned before the byproducts are passed through the screw press. The chemical pre-conditioning may include adjusting the pH of the byproducts, as by adding a caustic or magnesium hydroxide to the byproducts. The chemical pre-conditioning may also include adding at least one polymer to the byproducts.

In accordance with another embodiment of the present invention, it is believed that the foregoing advantages have been achieved through a system for the treatment of byproducts from the production of ethanol or alcohol spirits. This embodiment may include at least one screw press having an inlet and an outlet and adapted to dewater at least a first portion of the byproducts which pass through the screw press to produce a first wet cake product and a second filtrate product; and an anaerobic reactor having an inlet and an outlet adapted to receive and treat the second filtrate product.

The anaerobic reactor may be adapted to produce biogas from the treatment of the second filtrate product, and gas conditioning equipment may condition the biogas as a source of fuel. The system may also include at least one dryer for drying the wet cake product to produce an animal fed product. The system may also include chemical pre-conditioning equipment adapted to chemically pre-condition the byproducts, and the chemical pre-conditioning equipment may be disposed in a fluid transmitting relationship with the inlet of the at least one screw press. Chemical pre-conditioning equipment may include a pH adjustment apparatus and may also include a polymer treatment apparatus.

### BRIEF DESCRIPTION OF THE DRAWING

In the drawing:

FIG. 1 is a flow diagram of a process for the treatment of byproducts from an ethanol facility;

FIG. 2 is an overall flow diagram of a process for the treatment of byproducts from a distillery producing alcohol spirits, including schematic representations of various components used in the process; and

FIGS. 3-11 are enlarged portions, for the drawing clarity, of the overall flow diagram of FIG. 2.

While certain embodiments of the invention will be described in connection with the preferred embodiments shown herein, it will be understood that it is not intended to limit the invention to those embodiments. On the contrary, it is intended to cover all alternatives, modifications, and equivalents, as may be included within the spirit and scope of the invention as defined by the appended claims.

### DETAILED DESCRIPTION OF THE INVENTION AND SPECIFIC EMBODIMENTS

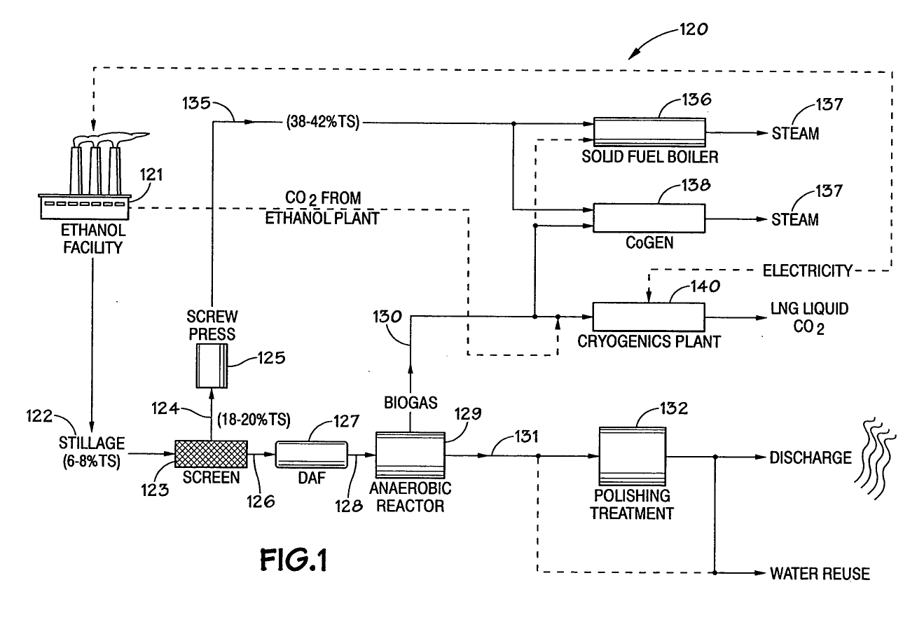

With reference to FIG. 1, one embodiment of an apparatus, or system, 120 for the treatment of distillation byproducts from an ethanol facility 121 is illustrated. The spent grains removed from the bottom of the ethanol facility 121, or whole stillage 122, containing 6-8% TS is passed over at least one, and preferably a plurality of screens, or screening devices, 123 with a size exclusion capability of approximately between 50 and 300 microns. If desired, the liquid that passes through screen, or screens 123, or set back, may be sent back to the ethanol facility 121. The thick stillage 124 is passed to a screw press 125 as will be hereinafter described. The thin stillage 126, or resultant water residual phase, may then be further processed by a dissolved air flotation system (“DAF”) 127, to recover most of the protein and fat from the thin stillage. The protein and fat, or DAF float solids, can be processed with the grain retained on the screen, or screens, 123 and may also be passed through the screw press 125. The DAF may serve as a water clarifier; however, the residual water stream 128 from the DAF may still contain considerable organics having a chemical oxygen demand (“COD”) from 20,000 to 30,000 mg/L. The residual water stream 128 may then be passed into a high-rate anaerobic reactor system 129 to produce biogas 130, typically methane. As illustrated in FIG. 1, biogas 130 may be used a fuel on-site for the production of steam, production of electricity, hot water, or any combination thereof. Apparatus, or system 120, does not require the use of an energy intensive evaporator, as well as eliminates the previously utilized solubles drying steps which are energy also intensive. At the same time, energy in the form of the biogas 130 is produced which permits the treatment of the whole stillage to become a positive energy producer.

Preferably, the anaerobic reactor 129 is a Mobilized Film Technology (“MFT”) anaerobic reactor commercially available from Ecovation, Inc. of Victor, N.Y. The fluid 131 exiting the reactor 129 may, if desired, be piped into a polishing treatment tank or polishing equipment 132, to further treat the resulting water for reuse. Alternatively, the resulting water stream 131 may bypass the polishing treatment tank 132 and be discharged directly into a public sewer. The polishing treatment tank 132 may take the form of a DAF or other water clarification device, which may further treat, or polish, the water stream 131.

Still with reference to FIG. 1, the thick stillage 124 is passed into screw pass 125 to be concentrated, or dewatered, until wet grain, or wet cake, 135 having approximately 38%-42% TS is formed. The wet cake 135 may be burned in a solid fuel boiler 136 to generate steam 137. Alternatively, the wet cake 135 may be dried in a conventional manner to form DDG. Alternatively, the wet cake 135 may be fed into a combined heat and power unit (“CHP”) to generate steam, or a CoGen Unit 138 as shown in FIG. 1 to also generate steam 137. Lastly, the biogas 130 may be piped into a cryogenics plant 140 to produce liquefied natural gas and carbon dioxide.

The screw press 125 may be any commercially available screw press, which is capable of concentrating the thick stillage 124 into the desired wet cake 135. Typically, screw press 125 has a relatively simple construction and is easy to maintain , as well as energy efficient in its operation.

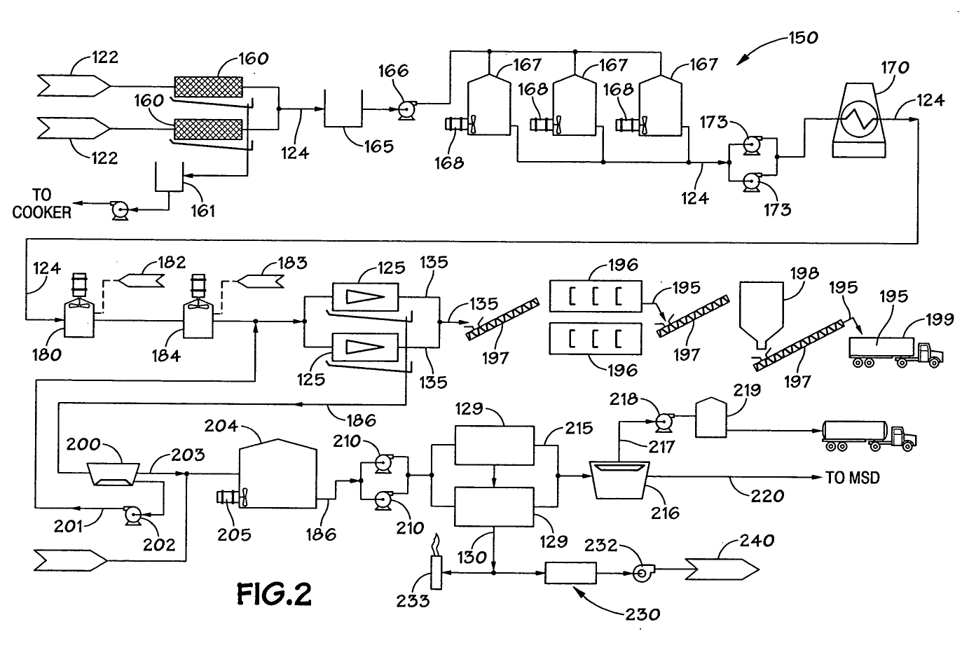

With reference to FIGS. 2-11, an embodiment of a method and apparatus for the treatment of byproducts from alcohol spirits production will be described. In FIGS. 2-11, whole stillage, or distillery bottoms, 122 from a still, or bourbon or other alcohol spirits distillery (not shown) are illustrated being treated. Additionally, the method and apparatus illustrated in FIGS. 2-11 could also be used to treat whole stillage from an ethanol facility 121, as previously described, or byproducts from any other facility that are capable of being treated by the method and apparatus 150 to be hereinafter described. In general, the method and apparatus 150 includes using a screw press 125 to dewater the spent grains or thick stillage 124, followed by anaerobic treatment of the screw press filtrate to convert the soluble organics into energy, or fuel, in the form of biogas 130. It is believed that apparatus, or system, 150 has the ability to produce a DDGS equivalent in terms of nutritional value, while eliminating the high operation costs of evaporation, dehydration, and scrubbers and reducing the net energy required to produce the DDGS equivalent product. It is further believed that apparatus 150 de-bottlenecks the distillery operations and returns the byproduct treatment into a net profit making operation.

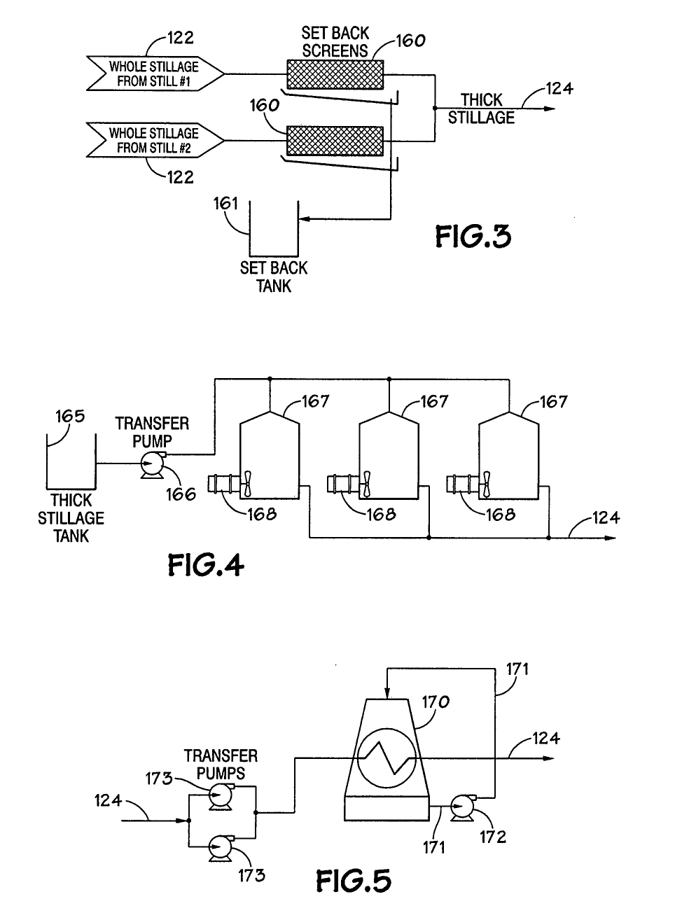

As shown in FIGS. 2 and 3, in order to maintain the required amount of setback 160, previously described to be sent back to the mashing process, existing conventional trough screens 160 and setback tank 161 are utilized as previously described.

The thick stillage 124 from screens 160 passes into a thick stillage tank 165 and by use of a transfer pump 166, the thick stillage 124 is conveyed into at least one, and preferably two or three, or more, stillage storage tanks 167, as shown FIGS. 2 and 4. Each tank 167 may be equipped with a side-mounted mixer 168. These tanks may provide approximately 15 hours of equalization of the thick stillage 124.

Whole stillage 122 as it emerges from the distillation tower, or still, (not shown), is very close to boiling point or approximately 200° F. Some environmental cooling occurs through the setback screens 160 and storage in tanks 165 and 167. Preferably, the thick stillage 124 should be cooled from 200° F. to the temperature of 100° F., which is approximately the optimal temperature for mesophilic anaerobic treatment. An efficient and practical system to accomplish this cooling is with a closed circuit cooling tower 170 as shown in FIGS. 2 and 5. Cooling tower 170 may be equipped with internal stainless steel evaporation cooling piping. Reserve water 171 below the cooling tower 170 may be circulated and cascaded over the cooling piping as by a pump 172. Fans may also be used to aid in the cooling process. Preferably, a steady process temperature of approximately 100° F. will be maintained. A transfer pump, or pumps 173 may be used to pump thick stillage 124 through tower 170. The use of cooling tower 170 provides potential heat recovery for use in the distillery. If feasible, incoming city water, boiler make-up water, or boiler feed water can be preheated via tube and tube heat exchangers (not shown) using the heat of the thick stillage, as the water passes the heat exchangers.

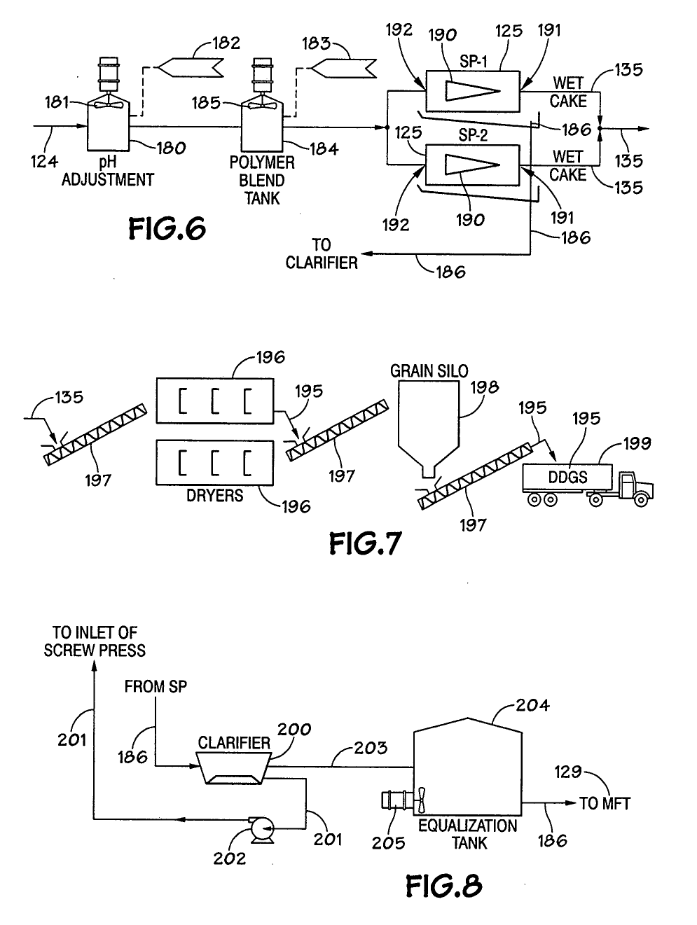

The thick stillage 124 exiting from the cooling tower 170 may then be conveyed to at least one screw press 125 for dewatering the thick stillage. While in the embodiment illustrated in FIGS. 2 and 6, two screw presses are illustrated, it will be readily apparent to one of ordinary still in the art that the number of screw presses 125 could be varied, as could the number of screens 160 (FIG. 3), or tanks 167 (FIG. 4) or any other equipment hereinafter described dependent upon the size of the various types of equipment, the amount of stillage being treated, and desired operation redundancies. Preferably, as shown in FIGS. 2 and 6, the thick stillage if desired, may be chemically pre-conditioned, or pre-treated, prior to being conveyed into the screw presses 125. It is believed that such pre-conditioning, as hereinafter described, improves the efficiency and performance of the screw presses 125 to achieve a higher percentage of TS for the wet cake 135.

As shown in FIGS. 2 and 6, the pH of the thick stillage 124 may be adjusted as by passing the thick stillage through a pH adjustment tank 180, which may include an agitator 181. Various materials, or pH adjusting chemicals, 182 may be added, such as magnesium hydroxide, caustic, or lime to adjust the pH of the stillage 124. The chemical 182 may be pumped into tank 180 by use of any suitable conventional pump, not shown. After the pH has been adjusted, it may also be pre-treated by adding to the thick stillage 124 a polymer 183 to increase the flocculation of thick stillage 124, prior to entering the screw presses 125. A polymer blend tank 184 may be used to blend the polymer into the stillage 124, as by use of an agitator 185 in tank 184. A suitable pump (not shown) may be used to pump the polymer into the tank 184.

A single polymer 183 may be used, but multiple polymers, if desired, could be combined and used. Preferably a GR designated polymer is used and such polymers 183 are a generally recognized as safe (“GRAS”) polymer. An example of one polymer which may be used is Ashland 2449 GR polymer, commercially available from Ashland, Inc.

From the polymer blend tank 184, the pre-treated thick stillage 124 passes into the screw presses 125, as shown in FIGS. 2 and 6. The screw press 125 is a relative simple, low maintenance mechanical device and has been found to be efficient and effective as a dewatering unit for processing thick stillage 124. Dewatering is continuous and is accomplished by gravity drainage to the inlet end of the screw 190 of the screw press 125, with reduction in volume as the material 124 is conveyed along the screw press 125 to its discharge end 191. As compared to prior centrifuge distillery dewatering equipment, screw presses 125 require less energy, or horse power, lower maintenance since it operates at single digit rpm versus thousands of time higher for centrifuges, and produce a higher percent TS wet cake 135. A higher TS value reduces the energy requirement during the drying process. With pre-treatment of the stillage 124, the filtrate 186 (FIGS. 2 and 8) or thin stillage 126 (FIG. 1) is significantly lower as compared to centrates from centrifuge processes or the filtrate from the existing paddle screens and roller press combination. Due to the higher capture rate of TSS by the screw press 125 with chemical pre-conditioning of the stillage 124, the wet cake 135 animal feed value is consistent with DDGS, thus maintaining the protein, crude fiber, crude fat, amino acids and minerals composition, Thus, currently used evaporators, dehydrators, and existing paddle screen and roller presses, are not required. The at least one screw press 125 may be a FKC screw press obtained from Fukoku Kogyo Company of Tokyo, Japan, or FKC Co., Ltd. of Port Angeles, Wash.

To produce DDGS 195, steam tube rotary dryers 195 may be utilized to dry the wet cake 135. The wet cake 135 from the screw press 125 will be higher in TS compared to previously used roller presses and as a result, the dryers 195 will require less energy to operate. A conventional conveyor system 197, grain silo 198, and truck loading area 199 may be utilized.

As previously described, the filtrate 186 is collected at the inlet end 192 of the screw press 125 and gravity drained. As shown in FIGS. 2 and 8, a gravity clarifier 200 may be used to capture any residual flocculated particles that are extruded through the screens. The underflow 201 from the clarifier 200 may be pumped as by a conventional pump 202, back to the front ends 192 of the screw presses 125 to maximize the overall solids capture rate. The clarified screw press filtrate 203 may be pumped to an intermediate equalization (“EQ”) tank 204. This tank 204 may be an above ground steel bolted tank with a side wall mixer 205 or an equivalent mixer. Tank 204 may have a floating cover to eliminate any potential odors and may be sized to provide a hydraulic capacity of 24 hours storage between the solids separation processes and the anaerobic bioreactors 129 (FIGS. 2 and 9).

As shown in FIGS. 2 and 9, the filtrate 186, or clarified screw press filtrate 203, may then be pumped, as by conventional pumps 210, to a high-rate anaerobic treatment provided by an anaerobic reactor, or reactors 129, as previously described, to treat the filtrate and to produce biogas 130. The feed system to the reactors 129 may be fully automated through a PLC control system (not shown). Instrumentation may monitor influent feed, temperature, pH, reactor pH, biogas production, recycle pumps, distribution valves, and reactor pressure. If any operation parameter is out of specifications, the control system may alert the operator. The control system may be equipped with remote monitoring. Biogas 130 is collected at the top of the reactors 129 and sent to biogas handling equipment, 230 (FIG. 11) as hereinafter described.

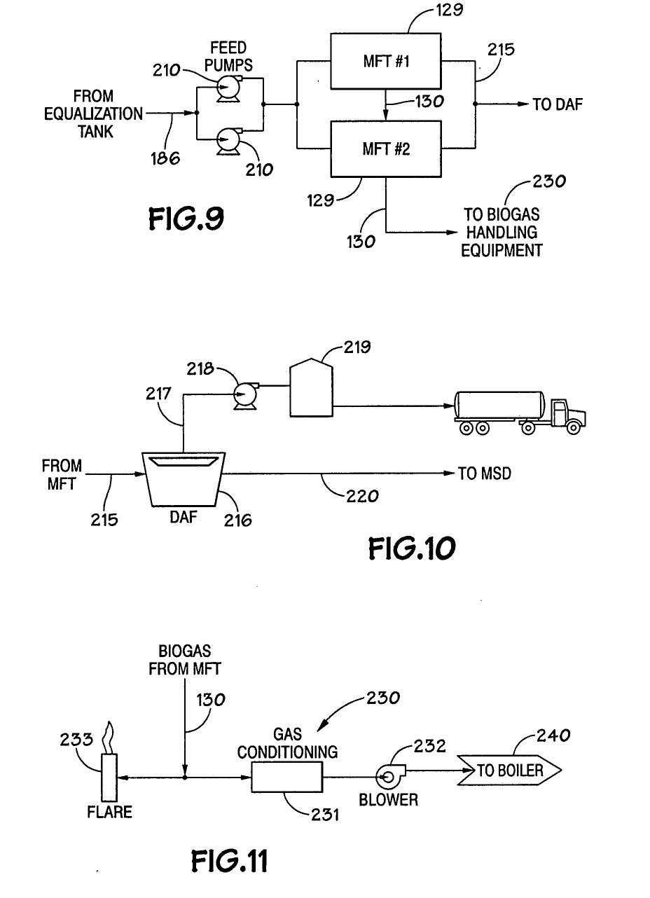

As shown in FIGS. 2 and 10, excess biomass and undigested suspended solids simply pass through the anaerobic treatment reactors 129 and are discharged in the effluent 215. Anaerobic biomass, due to its ability to produce biogas 130, has a propensity to float and a dissolved air flotation, or DAF, system 216 may be provided, if desired, to remove effluent TSS. For example, a Krofta Technologies' Multifloat DAF unit may be used to remove TSS from the anaerobic reactor 129 and to clarify the water. In the DAF, the influent feed may be blended with aerated water. Microscopic air bubbles in the aerated water attach to the suspend solids causing the solids to become buoyant and float. Solids 217 simply float to the surface and are scooped up and gravity fed to a sludge pit and may be pumped, by a conventional pump 218 to a sludge storage tank 219. Clarified effluent (subnanant) 220 from the DAF 216 may be gravity discharged to the metropolitan sewer district.

Biogas 130, generated by the anaerobic treatment of the organic waste streams, is composed of mainly methane and CO₂ and is collected at the top of the anaerobic reactors 129. The reactors 129 may be operated under low pressure, that is sufficient to drive the produced gas to the biogas handling equipment 130, as shown in FIG. 11. The biogas can be utilized as a renewable source of fuel. If desired, the gas to be used in the natural gas steam boiler may be conditioned by gas conditioning equipment 231. The biogas conditioning may include sediment removal, and water condensate removal. The conditioned gas is then available for use as a fuel. Depending on the location of the boiler 240 in relationship to the anaerobic reactors 129, either a simple gas blower, or compressor, 232 may be used to deliver the gas 130. In the event that the biogas 130 is not being utilized, it may be burned in a conventional flare system 244.

Throughout the drawing, it should be noted that conventional piping is illustrated for conveying, as in a fluid transmitting relationship, the various materials and byproducts herein described as will be understood by those skilled in the art.

Specific embodiments of the present invention have been described and illustrated. It will be understood to those skilled in the art that changes and modifications may be made without departing from the spirit and scope of the inventions defined by the appended claims.

We claim:

1. A method for the treatment of byproducts from the production of ethanol or alcohol spirits comprising the steps of:
passing at least a first portion of the byproducts through at least one screw press to dewater the first portion of the byproducts to produce a first wet cake product and a second filtrate product; and
passing at least a portion of the second filtrate product through an anaerobic reactor to treat the second filtrate product

2. The method of claim 1, including the step of utilizing the anaerobic reactor to produce a biogas.

3. The method of claim 2, including the step of using the biogas as a source of fuel.

4. The method of claim 2, including the steps of: conditioning the biogas; and using the biogas as a source of fuel.

5. The method of claim 1, including the steps of treating the wet cake product to produce an animal feed product.

6. The method of claim 1, including the step of chemically pre-conditioning the at least first portion of the byproducts before the portion of byproducts is passed through the at least one screw press.

7. The method of claim 6, wherein the chemical pre-conditioning includes the step of adjusting the pH of the at least first portion of the byproducts.

8. The method of claim 7, wherein caustic or magnesium hydroxide is used to adjust the pH of the at least first portion of the byproducts.

9. The method of claim 6, wherein the chemical pre-conditioning includes the step of adding at least one polymer to the at least first portion of the byproducts.

10. The method of claim 9, wherein the at least one polymer is a polymer which is generally regarded as safe.

11. The method of claim 1, wherein the byproducts are whole stillage.

12. A system for the treatment of byproducts from the production of ethanol or alcohol spirits comprising:
at least one screw press having an inlet and an outlet and adapted to dewater at least a first portion of the byproducts which pass through the at least one screw press to produce a first wet cake product and a second filtrate product; and
an anaerobic reactor having an inlet and an outlet adapted to receive and treat the second filtrate product.

13. The system of claim 12, wherein the anaerobic reactor is adapted to produce biogas from the treatment of the second filtrate product.

14. The system of claim 13, including gas conditioning equipment adapted to condition the biogas as a source of fuel.

15. The system of claim 12, including at least one dryer for drying the wet cake product to produce an animal feed product.

16. The system of claim 12, including chemical pre-conditioning equipment adapted to chemically pre-condition the at least first portion of the byproducts, the chemical pre-conditioning equipment being disposed in a fluid transmitting relationship with the inlet of the at least one screw press.

17. The system of claim 16, wherein the chemical pre-conditioning equipment includes a pH adjustment apparatus adapted to permit a pH adjusting chemical to be added to the first portion of the byproducts.

18. The system of claim 17, wherein the pH adjustment apparatus includes a pH adjustment tank.

19. The system of claim 16, wherein the chemical pre-conditioning equipment includes a polymer treatment apparatus adapted to permit at least one polymer to be added to the first portion of the byproducts.

20. The system of claim 12, including a clarifier in a fluid transmitting relationship with the inlet of the at least one anaerobic reactor.
